(19) United States
(12) Patent Application Publication
(10) Pub. No.: US 2015/0285435 A1
(43) Pub. Date: Oct. 8, 2015

(54) Oiling System for Door Hinges

(71) Applicant: Abdullah S. Alghamdi, Newark, DE (US)

(72) Inventor: Abdullah S. Alghamdi, Newark, DE (US)

(21) Appl. No.: 14/676,805

(22) Filed: Apr. 1, 2015

Related U.S. Application Data
(60) Provisional application No. 61/995,089, filed on Apr. 2, 2014.

(51) Int. Cl. F16N 7/02; E05D 5/10; F16N 39/06; F16N 31/02

(52) U.S. Cl. CPC F16N 7/02; F16N 31/02; E05D 5/10; F16N 39/06; E05D 2005/102

(57) ABSTRACT

Oil System for Door Hinges is a mechanism that provides door hinges with consistent oiling to prevent the problems related to the lack of lubrication. It is mainly a small tube placed on the top of the hinge pin cap. It is provided with an oil container and a filter to control the flow of the oil. The excessive oil can be collected through another tube which is attached immediately under the lower end of the hinge pin.

### CROSS-REFERENCE TO RELATED APPLICATIONS

This non-provisional application corresponds to an early filed provisional application (to take advantage of that earlier filing date) with the following information:

Application Number: 61/995,089

Filing Date: Apr. 02, 2014

### BACKGROUND OF THE INVENTION

The invention aims to solve the problems resulting from the friction between the parts of door hinges, especially the problem of noisy sounds when opening or closing the doors. It should also increase the efficiency of door hinges through providing such mechanism. The main function of the invention is to supplying door hinges with consistent oiling mechanism that insures sooth friction between its parts.

### BRIEF SUMMARY OF THE INVENTION

The invention consists mainly of two parts. The first part is a tube placed and attached to the upper hinge knuckle or the upper tip of the hinge pin immediately above the pin cap. The body of the tube serves as a container for lubricating oil. The lower end of this container is sealed with a filter to control the flow of the oil. The upper end of the tube is open to refill with oil.

The second part is a tube attached to the lowest hinge knuckle. The lower part of the tube serves as a container which has a completely sealed lower end. The aim of this part is to collect the excessive oil that flows from the upper tube.

### BRIEF DESCRIPTION OF THE SEVERAL VIEWS OF THE DRAWING

The numbers in each figure and the terms used in this brief description of the drawings will be explained in details in 6 below (detailed description of the invention).

FIG. 1: general view of the upper tube.

FIGS. 2 & 3: show how the upper tube is attached.

FIG. 4: integrated model of the upper tube with a removable pin tip (cap)

FIG. 5: shows the hinge pin where the model in FIG. 4) is attached.

FIG. 6: shows how the model in FIG. 4) is attached to the hinge pin in FIG. 5).

FIG. 7: integrated model of the upper tube with a fixed pin tip (cap).

FIG. 8: general view of the lower tube and it is attachment to the lowest knuckle.

FIG. 9: cross-section of improved lower tube.

FIG. 10: pre-filled disposable model with double filters

FIG. 11: Osmotic model

### DETAILED DESCRIPTION OF THE INVENTION

The invention comes in different types that have the common function of providing consistent controlled oiling mechanisms for door hinges. I will explain each model in details.

### The Separated Models

Theses models are used for the hinges that don't have integrated oiling mechanism (like most of the ordinary hinges in the household). These models come in two types:

### The Refillable Separated Model

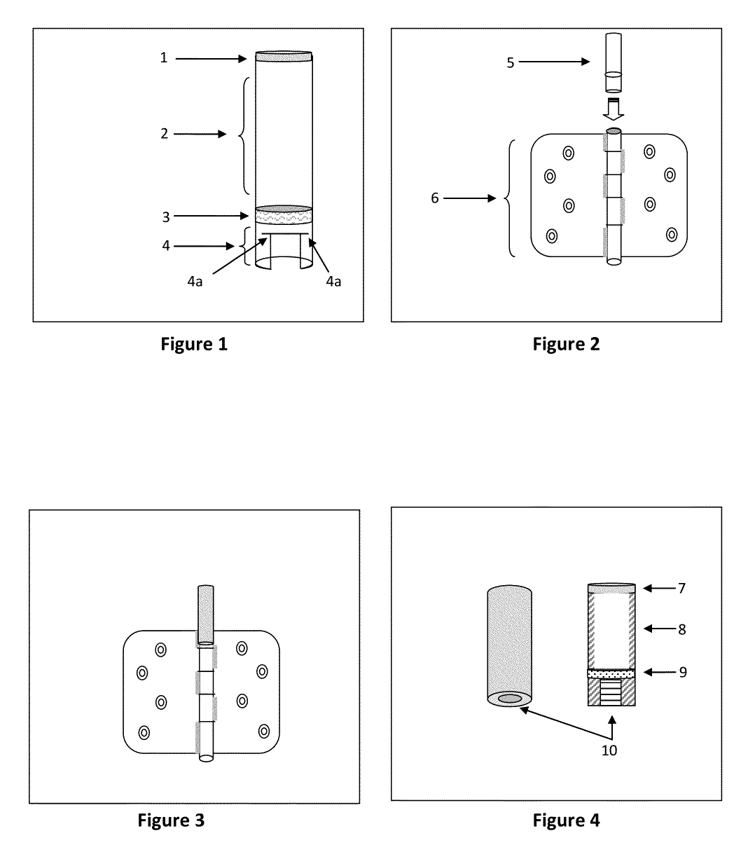

This model is very simple; it is an article that is mostly tube-shaped and made of plastic (henceforth I will refer to this article as “the tube”) as in FIG. 1). The tube consists of a sealing cap (FIG. 1, No. 1), a hollow space that serves as an oil container (FIG. 1, No. 2), a filter (FIG. 1, No. 3), and a base which is normally the extension of the tube (FIG. 1, No. 4). As shown in FIG. 2), this tube (FIG. 2, No. 5) is to be installed on the hinge knuckle (FIG. 2, No. 6) just above the cap of the hinge pin. The base is designed to hold the tube in its position on the hinge (FIG. 3). There is a small square cut in the base to allow the tube to be inserted deeper into the hinge and hold firmly. The top cut of the square (FIG. 1, No. 4a) is longer than the bottom so the tube may adjust to small differences in hinge tip size. However, the tube can be attached to the pin cap only (I built a model that is fixed on the pin cap without the support of the hinge knuckle by matching the circumferences of both: the base of the tube and the cap of the hinge pin where the latter is standardized). After the tube is placed, the container may now be filled with lubricating oil which, by the power of gravity, flows slowly into the hinge to alleviate the friction. The main purpose of the oil filter (FIG. 1, No. 3) is to delimit the oil flow so the oil reservoir would last for longer time. The filter can be made of any material that has a low rate in absorbing oil such as cork. For a better organize of oil flow, the opening of the lower end of the container can also be controlled (along with controlling the size, shape and material of the filter). Another way of controlling the flow of the oil is by filling the container with an oil absorbent material that releases the oil slowly through the lower opining. For consistent oiling, the container is refilled when almost empty.

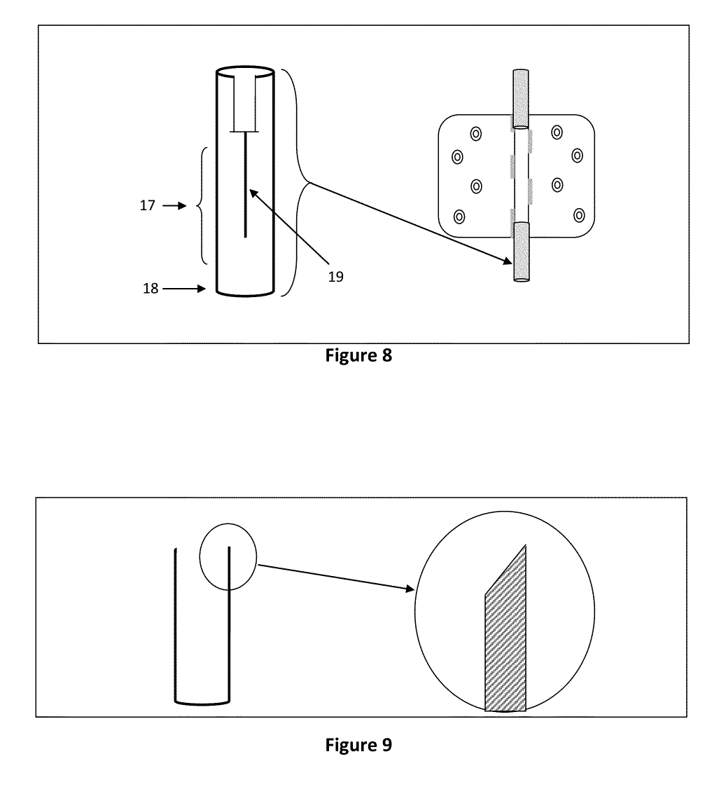

The second part of the invention is another tube that is attached to the lowest knuckle of the hinge. It has a chamber (FIG. 8, 17), a sealed bottom end (FIG. 8, 18) and an inside oil passage (FIG. 8, 19) to collect the excessive oil (if there is any). To improve the quality of this lower tube, the upper edge of the tube can be cut tilted toward the inside (FIG. 9) to prevent the excessive oil from reaching the outside walls of the tube.

### The Prefilled Disposable Separated Model

This model has exactly the same structure of the model in (a1) above. The difference is that tube is filled with oil during the manufacturing process then the top of the tube is permanently sealed. The bottom end has a detachable seal or cap that can be removed before placing the tube on the top of the hinge as described in (1a).

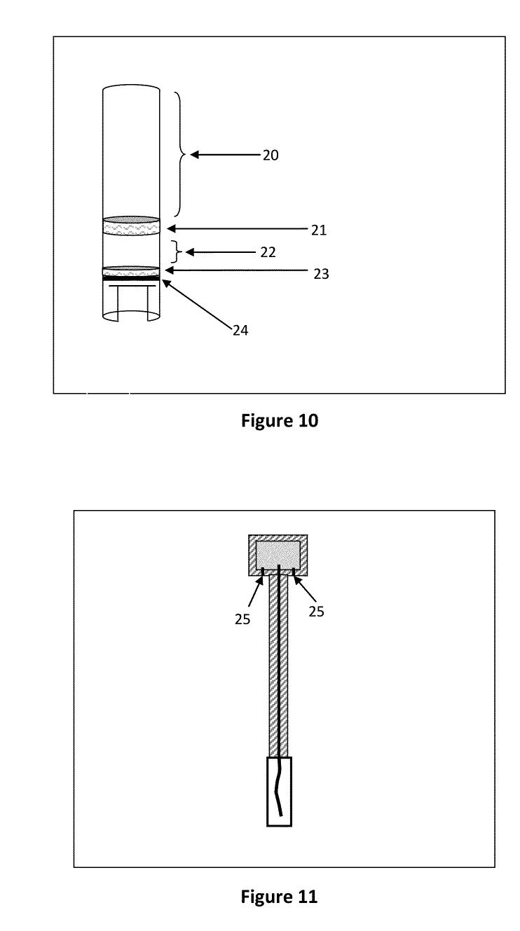

This model can be improved by comprising two chambers: large (FIG. 10, 20); small (FIG. 10, 22) and two filters: heavy (FIG. 10, 21); light (FIG. 10, 23). Both chambers are prefilled with oil before placing the detachable seal (FIG. 10, 24). The filters have significant discrepancies in the rate of oil flow they allow. The idea is that the light filter allows faster flow of the oil in the smaller chamber for quick oiling of the hinge then the heavy filter prolongs the flow of the oil in the large chamber. For example, oil in the smaller chamber is fully released in 3 hours while oil in the larger chamber may take 3 months. The chambers and the filters can also be designed to be parallel.

### The Integrated Models

These models have exactly the same function as the separated models. The difference is that in this case the model is an actual part of the hinge pin. It is supposed to be made with the same material as the hinge (e.g. metal).

### The Integrated Model With A Removable Tip.

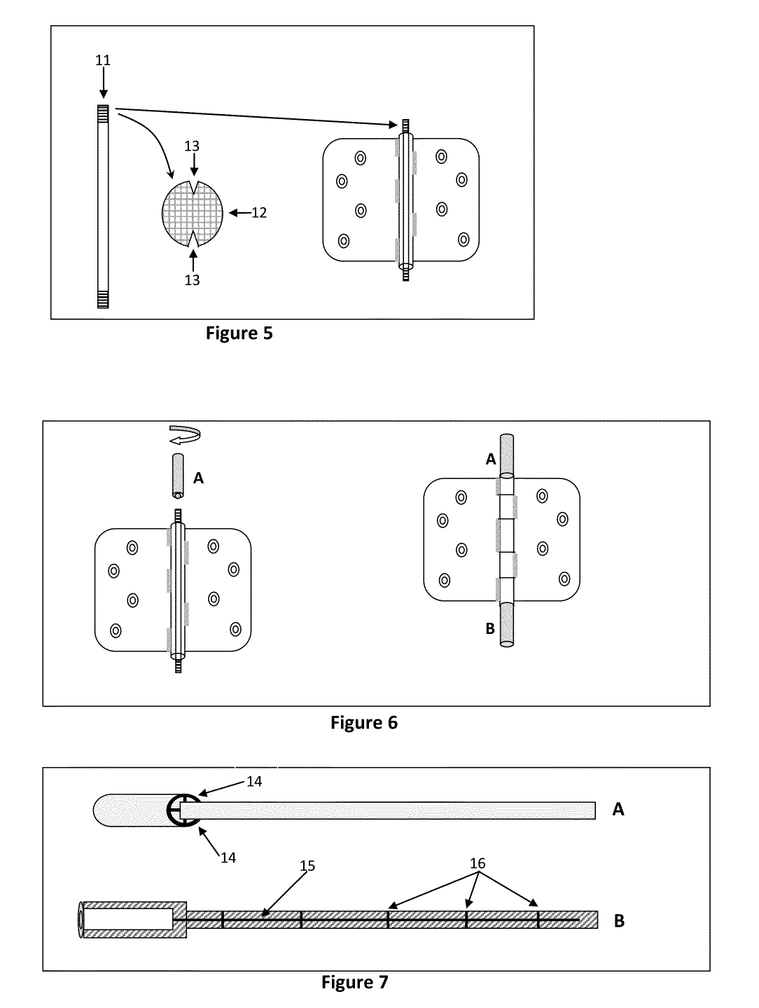

This type of the integrated model is attached only to the hinge pin. On the left side of FIG. 4) is the outer shape of this model; it also has a tube shape. The right side of FIG. 4) shows a cross-section of the model. It is similar to the previous model; it has a cap (FIG. 4, No. 7), a container (FIG. 4, No. 8) and a filter (FIG. 4, No. 9). The base of this model has a screw hole (FIG. 4, No. 10). The hinge pin (FIG. 5, No. 11) that this model is attached to should have a tip where the screw hole fits. The top view of the pin (FIG. 5, No. 12) shows that the pin tip has two small notches (FIG. 5, No. 13) to allow the filtered oil flows; the notches can instead be curved inside the screw hole of the tube to provide a passage for oil. After the pin is placed in the hinge, the tube is installed in the visible part of the pin (FIG. 6, A). The container is then filled with oil which flows consistently in very small amounts to lubricate the pin and the hinge.

The excessive oil collecting tube (second part of the invention) is also made of the same material of the hinge. It has a screw hole with notches in the inside wall to allow oil pass to the container. It is attached to the lower screw end of the pin (FIG. 6, B). To insure that oil does not flow on the outside walls of this part, the tube maybe separated from the knuckle by a small space; the top edge of the tube can tilted towards inside.

### The Integrated Model With A Fixed Tip.

This model has exactly the same design as the integrated models with removable/disposable tips in (a) above. The only difference is that the tube is fixed to the pin (not detachable) as in (FIG. 7, A). It also has a sealing cap and a filter. The oil flows to the sides of the pin from the openings indicated by (No. 14) in FIG. 7).

### Heavy Duty Model.

This model (FIG. 7, B / cross-section) is suitable for hinges that are prone to heavy frequent use. The tube is fixed to the pin. It has a cap and a container for the oil. It doesn't have a filter instead it has a canal starting from the oil container deep into the pin. The canal doesn't penetrate the pin to the end; it stops before the end, so it is opened only from the top (FIG. 7, No. 15). There are side openings (FIG. 7, No. 16) to let the oil out lubricating the pin and the hinge. The canal can be filled with oil absorbent material to control the flow of the oil.

### Osmotic Model

As FIG. 11) shows, the hinge pin design of this model has a central canal that starts at the bottom of the pin which extends to a chamber in the cap of the pin. The canal and the chamber are filled with an oil absorbent material which extends beyond the entrance of the canal into the oil chamber of the lower tube (second part of the invention). The cap has opening (FIG. 11, 25) to allow oil to flow on the sides of the pin. The oil climbs to the upper chamber in the cap by the virtue of the osmotic property. The lower tubes serves both as an oil provider and excessive oil collector.

All the models above may come in different sizes or shapes for decorative or other purposes. The oil may be scented.

What is claimed is:

1- An article which is placed on the top of the hinge pin and comprises: a lubricant chamber, a sealing cap and a filter at the bottom of the lubricant chamber to delimits the lubricant flow.

2- The article base in claim 1) is attached to the highest knuckle of the hinge.

3- The article base in claim 1) is attached to the cap of the hinge pin.

4- The article in claim 1) is an integrated part of the cap of the hinge pin and not removable.

5- The flow of the oil from the lubricant chamber in claim 1) is controlled by the size, shape and material of the filter.

6- The flow of the oil from the lubricant chamber in claim 1) is controlled by the size the bottom opening of the lubricant chamber.

7- The article in claim 1) is prefilled with the lubricant where it has a permanent upper seal and a detachable bottom seal.

8- The article in claim 7) is disposable.

9- The article in claim 8) which has:
a. two oil chambers : large; smaller
b. two filters: heavy; light
where the oil in the large chamber flows through the heavy filter to the smaller chamber then through the light filter and the oil flow rate of the heavy chamber is significantly lower than the rate of oil flow through the light filter.

10- The article in claim 1) constitutes a removable decorative upper hinge pin tip.

11- A cylindrical tube that fixed under the lower end of the hinge pen to collect the excessive oil flowing from the lubricant chamber mentioned in claim 1).

12- The cylindrical tube in claim 11) is attached to the lowest knuckle of the hinge.

13- The cylindrical tube in claim 11) constitutes a removable decorative lower hinge pin tip.

14- The cylindrical tube in claim 11) has upper edge that is tilted inwards.

15- A hinge pin that has a central canal where lubricating oil can flow.

16- The canal in claim 15) is filled with an oil absorbent material.

17- The absorbent material in claim 16) stretches outside the canal at the lower end of the pin.

18- The chamber in claim 1) is filled with an oil absorbent material.
